(19) United States
(12) Patent Application Publication
(10) Pub. No.: US 2014/0199580 A1
(43) Pub. Date: Jul. 17, 2014

(54) ELECTRONIC DEVICE

(71) Applicant: SEMICONDUCTOR ENERGY LABORATORY CO., LTD., Atsugi-shi (JP)

(72) Inventor: Shunpei YAMAZAKI, Tokyo (JP)

(73) Assignee: SEMICONDUCTOR ENERGY LABORATORY CO., LTD., Atsugi-shi (JP)

(21) Appl. No.: 14/153,184

(22) Filed: Jan. 13, 2014

(30) Foreign Application Priority Data
Jan. 14, 2013 (JP) 2013-004161

(51) Int. Cl. H01M 10/44; H01M 10/42

(52) U.S. Cl. CPC H01M 10/441; H01M 10/4207
USPC 429/158

(57) ABSTRACT

To provide an electronic device having high capacity and high reliability. To provide an electronic device with a small size which can be provided indoors even when it has high capacity. The electronic device includes a plurality of battery cells connected in series. The plurality of battery cells each include a first electrode, a second electrode, and an electrolytic solution between the first electrode and the second electrode. A reaction product, which grows from a surface of the first electrode when a current is supplied between the first electrode and the second electrode, is dissolved from its tip or surface by applying a signal to supply a current reverse to the current. The electronic device is stored in an underfloor space surrounded by a base and a floor of a building.

### BACKGROUND OF THE INVENTION

1. Field of the Invention

The present invention relates to an electronic device and a manufacturing method thereof. In addition, the present invention relates to a system having a function of reducing the degree of degradation of an electronic device.

Note that an electronic device in this specification and the like generally means a device that can operate by utilizing a battery (also referred to as a power storage device), a conductive layer, a resistor, a capacitor, and the like.

2. Description of the Related Art

In recent years, a variety of power storage devices such as battery cells including lithium-ion secondary batteries and the like, lithium ion capacitors, and air cells have been actively developed. In particular, demand for lithium-ion secondary batteries with high output and high energy density has rapidly grown with the development of the semiconductor industry, for electrical devices, for example, portable information terminals such as mobile phones, smartphones, and laptop computers, portable music players, and digital cameras. The lithium-ion secondary batteries are essential as rechargeable energy supply sources for today's information society.

When power supply equipment malfunctions or is partly broken or an electric power company stops or suppresses power supply because of natural disasters (e.g., crustal movement such as earthquakes and ground subsidence, typhoons, and lighting strikes), terrorism, accidents, or the like, for example, not only social life but also personal lives might be significantly affected. Thus, demand of home-use power storage devices which can ensure electric energy by individuals has been increasing.

In addition, the lithium-ion secondary battery includes at least a positive electrode, a negative electrode, and an electrolytic solution (Patent Document 1).

### REFERENCE

### Patent Document

[Patent Document 1] Japanese Published Patent Application No. 2012-09418

### SUMMARY OF THE INVENTION

It is desirable that home-use power storage devices have high capacity and a long lifetime. However, when the capacity of the power storage devices is increased, the volume thereof is increased. Furthermore, when the lifetime of the power storage devices is increased, the volume efficiency is decreased, leading to an increase in the volume. When the volume of the power storage devices is increased, it is difficult to provide the power storage device indoors; thus, the power storage device needs to be provided outdoors.

However, when the power storage device is provided outdoors, the power storage device is exposed to rain or the like and thus degraded by moisture. Further, in the case where the power storage device is provided outdoors, when the outside air is at a low temperature (e.g., minus temperature range), the power storage device is significantly degraded, so that the lifetime of the power storage device is decreased. In order to suppress degradation of the power storage device, regular maintenance of the power storage device is required; thus, in addition to cost for purchasing the power storage device, maintenance cost and the like are further needed. Consequently, burdens of cost of a power storage device are large for an individual.

In the case where a home-use power storage device is possessed by an individual and provided outside an individual house (building), the power storage device is provided on the premises that can be used by the individual. In the case where a ratio of a building area to the site area, that is, building-to-land ratio, is high, and the power storage device is provided in a space limited by an adjacent house or a wall, the size of the power storage device is necessarily considered. Even in the case where a large power storage device can be provided outside the individual house, it is difficult to ensure a carrying path for settlement. Note that outside a house means an area other than the building area.

In view of the above problems, an object of one embodiment of the present invention is to provide a power storage device with high capacity. Another object of one embodiment of the present invention is to provide a power storage device with a long lifetime. Another object of one embodiment of the present invention is to provide a power storage device with high reliability.

Further, another object of one embodiment of the present invention is to provide a small-sized power storage device which can be provided indoors even when the capacity thereof is high.

One embodiment of the present invention is an electronic device including a plurality of battery cells connected in series. Each of the plurality of battery cells includes a first electrode, a second electrode, and at least an electrolytic solution between the first electrode and the second electrode. A reaction product, which grows from at least one point of a surface of the first electrode due to a current between the first electrode and the second electrode, is dissolved from its tip or surface by applying a signal to supply a current reverse to the current. The electronic device is stored in an underfloor space surrounded by a base and a floor of a building.

According to one embodiment of the present invention, a power storage device with high capacity can be provided. A small-sized power storage device with high capacity which can be provided indoors can be provided. A power storage device having a long lifetime can be provided. The reliability of a power storage device can be improved.

When power storage devices of one embodiment of the present invention are widely used, as the number of houses which include the power storage devices of one embodiment of the present invention indoors is increased, burdens of a power plant in a region where the houses are located are reduced, which can contribute to an effective use and a stable supply of power. Further, according to one embodiment of the present invention, the power storage device is charged in the night time when the use amount of power is small, and is used in the day time when the use amount of power is large; thus, power can be efficiently charged and used. Furthermore, since the power storage device is used in the day time when the usage charges of a commercial power source are high, the electricity charges are low and an economic merit can be obtained.

### BRIEF DESCRIPTION OF THE DRAWINGS

In the accompanying drawings:

FIGS. 1A and 1B are diagrams each illustrating a power storage device stored under a floor of a building;

FIGS. 2A to 2F are schematic cross-sectional views illustrating one embodiment of the present invention;

FIGS. 3A to 3F are schematic cross-sectional views illustrating one embodiment of the present invention;

FIGS. 4A to 4F are schematic cross-sectional views illustrating one embodiment of the present invention;

FIGS. 5A and 5B are diagrams illustrating a positive electrode;

FIGS. 6A and 6B are diagrams illustrating a negative electrode;

FIGS. 7A to 7C are diagrams each illustrating a battery cell;

FIG. 8 is a diagram illustrating a power storage system using a power storage device;

FIG. 9A is a graph showing thicknesses of components of each of battery cells and FIG. 9B is a graph showing cell capacity of each of the battery cells;

FIGS. 10A and 10B are graphs each showing cycle characteristics; and

FIGS. 11A and 11B are graphs each showing cycle characteristics.

### DETAILED DESCRIPTION OF THE INVENTION

Hereinafter, embodiments of the present invention will be described in detail with reference to the accompanying drawings. However, the present invention is not limited to the following description, and it is easily understood by those skilled in the art that modes and details disclosed herein can be modified in various ways. Therefore, the present invention is not construed as being limited to description of the embodiments and the examples.

### Embodiment 1

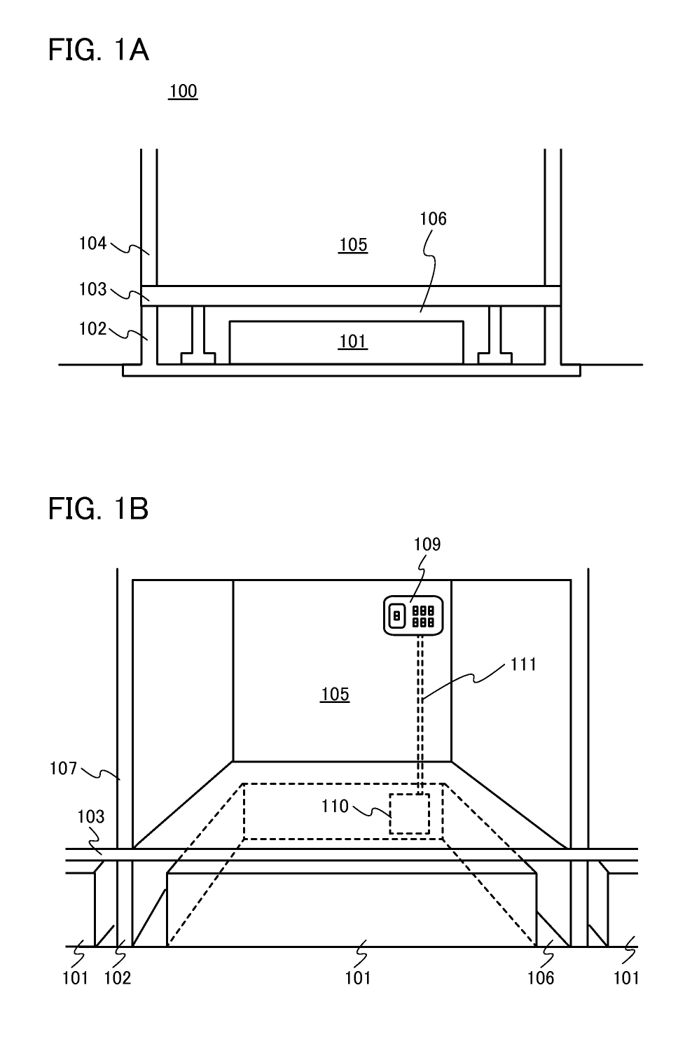

In this embodiment, a power storage device of one embodiment of the present invention will be described with reference to FIGS. 1A and 1B.

A building 100 illustrated in FIG. 1A includes a base 102, a floor 103, an exterior wall 104, a space 105, and an underfloor space 106. A power storage device 101 (also referred to as an electronic device) of one embodiment of the present invention is stored in the underfloor space 106, which is surrounded by the base 102 and the floor 103 of the building 100.

Further, as illustrated in FIG. 1B, the underfloor space 106 is surrounded by the base 102 in the building 100. Further, the inside of the building 100 is partitioned by an interior wall 107. The power storage device 101 is stored in the underfloor space 106. In the case where there are a plurality of underfloor spaces 106 surrounded by the base 102, the power storage device 101 can be stored in each of the underfloor spaces 106.

The power storage device 101 of one embodiment of the present invention includes a plurality of battery cells.

A battery cell of one embodiment of the present invention prevents generation and growth of a reaction product, which causes occurrence of a variety of abnormal situations or degradation, formed on a surface of an electrode. Even if a reaction product is generated, the reaction product can be dissolved by applying a signal to supply a current reverse to a current with which the reaction product is formed.

The signal to supply the reverse current refers to a pulse voltage or a pulse current, and can also be referred to as a reverse pulse. Note that the pulse voltage refers to a voltage of a signal with which a voltage does not flow following one another or flow continuously but flows momentarily or continuously for a moment (for 0.1 seconds or longer and 3 minutes or shorter, typically 3 seconds or longer and 30 seconds or shorter).

Inputting a reverse pulse before generation of a reaction product prevents growth of a reaction product. In addition, inputting a reverse pulse repeatedly during charging of a battery cell prevents growth of a reaction product; thus, a battery cell with theoretically no degradation can be provided.

When the power storage device 101 includes a plurality of such battery cells, the reliability of the power storage device 101 can be increased. Thus, the lifetime of the power storage device 101 can be increased, so that regular maintenance of the power storage device 101 is not needed or the frequency of maintenance can be reduced. Since regular maintenance of the power storage device 101 of one embodiment of the present invention is not needed, it is unnecessary to provide a workspace for maintenance around the power storage device 101. Accordingly, the power storage device 101 can be provided indoors. Note that in this specification and the like, “provided indoors” means “provided in an area of a building (except a rooftop) when seen from above” and includes an underfloor space of the building and a basement of the building in a category of indoors.

Further, by inputting a reverse pulse while the battery cell is charged, heat generating or ignition of the battery cell due to a short circuit caused by a reaction product formed on a surface of an electrode of the battery cell can be prevented. In other words, since the safety of the power storage device 101 including the battery cell can be improved, the power storage device 101 can be stored (or provided) in the underfloor space 106.

In order to ensure the safety of the power storage device 101 more certainly, an exterior of the power storage device 101 preferably has measures against water and fire. Further, the base 102 and the floor 103 preferably have measures against water and fire.

Deposition of lithium in a negative electrode of a battery cell causes a variety of defects in the battery cell, for example; therefore, the reliability of the battery cell might be decreased. In order to prevent this, the capacity of a negative electrode is made larger than the capacity of a positive electrode (the capacity ratio is set to be low) in some cases. However, in a battery cell of one embodiment of the present invention, even if lithium is deposited in a negative electrode, the lithium is dissolved or made stable; thus, the reliability of the battery cell can be increased.

By inputting a reverse pulse while a battery cell is charged, the capacity ratio can be increased, so that capacity per cell volume can be significantly improved. The capacity ratio means a proportion of the volume capacity of a positive electrode to the volume capacity of a negative electrode, and when the capacity ratio can be high, whole volume capacity (the total of the volume capacity of the positive electrode and the volume capacity of the negative electrode) with respect to a certain capacity value can be small. That is, the size of the battery cell can be reduced.

Consequently, the power storage device 101 which is drastically downsized by using downsized battery cells can be provided indoors; specifically, the power storage device 101 can be stored in the underfloor space 106. The lifetime of the power storage device 101 is increased; thus, replacement of the power storage device 101 is not needed. Further, the size of the power storage device 101 may be increased to a size such that it is stored in the underfloor space 106.

By using a plurality of battery cells of one embodiment of the present invention, even if the volume of the power storage device 101 is increased, the increase in the volume thereof can be smaller than an increase in that of a conventional one; thus, the power storage device 101 is not needed to be provided outdoors and can be stored in the underfloor space 106. When the power storage device 101 is stored in the underfloor space 106 as described above, the power storage device 101 can be prevented from being exposed to rain or the like, so that degradation of the power storage device 101 due to moisture can be prevented. Further, even when the outside air is at a low temperature (e.g., minus temperature range), degradation of the power storage device 101 can be suppressed because the power storage device 101 is provided indoors. Accordingly, the lifetime of the power storage device 101 can be further increased.

The lifetime of a building such as an individual house is approximately 30 years after construction. The power storage device 101 of one embodiment of the present invention is stored in the underfloor space 106 and is preferably kept stored in the underfloor space 106 with no maintenance for 30 years, more preferably, for 50 years.

The power storage device 101 can be provided in the underfloor space 106 when or after the building 100 is built. The underfloor space 106 of the building 100 can be effectively used.

In the case where a conventional power storage device is provided outdoors, a wide area for providing the power storage device is needed. Further, when the power storage device is provided, it is necessary to ensure a workspace for maintenance around the power storage device.

Since the power storage device 101 of one embodiment of the present invention is provided in the underfloor space 106, a wide area for providing the power storage device 101 outdoors is not needed. Further, since the power storage device 101 is provided in the underfloor space 106, a workspace for maintenance is not needed around the power storage device 101.

The amount of power stored in the power storage device 101 of one embodiment of the present invention can be greater than or equal to 10 kWh and less than or equal to 40 kWh. In the case where the amount of power stored in the power storage device 101 is 40 kWh, for example, 400 battery cells with 100 Wh at 3.2 V are used. Since the size of the battery cell can be reduced as described above, an increase in volume of the power storage device 101 can be prevented even when the number of battery cells needed for the power storage device 101 is increased to more than 400. Further, for example, it is preferable that a graphite electrode be used as a negative electrode of the battery cell and lithium iron phosphate (LiFePO₄) be used for a positive electrode of the battery cell. In that case, the safety of the battery cell and the safety of the power storage device 101 including the battery cell can be increased.

For example, the power storage device of one embodiment of the present invention performs charging using an AC/DC converter in the night time and discharging using a DC/AC converter (e.g., 50 Hz or 60 Hz) in the day time. The power storage device 101 is charged in the night time when the use amount of power is small, and is used indoors in the day time when the use amount of power is large; thus, power can be efficiently charged and used. Further, since the power storage device 101 is used in the day time when the usage charges of a commercial power source are high, the electricity charges are low and an economic merit can be obtained. Note that the frequency and voltage at the time of using power stored in the power storage device 101 can be set as appropriate depending on a region (country) where the power storage device 101 is used.

As illustrated in FIG. 1B, the power storage device 101 is provided with a control device 110, and the control device 110 is electrically connected to a distribution board 109 through a wiring 111.

The control device 110 has a function of controlling charging and discharging of each battery cell, a function of protecting the battery cells from overcurrent and overvoltage, a function of controlling temperature, a function of controlling a battery balance between the battery cells, a function of outputting power to the distribution board 109, and the like.

A plurality of power storage devices 101 provided in the underfloor spaces 106 under rooms (spaces 105) each include the control device 110, and each of the control devices 110 may be electrically connected to the distribution board 109 through the wiring 111.

Next, a mechanism for forming a reaction product on a surface of an electrode and a mechanism for dissolving the reaction product in the battery cell used for the power storage device 101 are described.

The reaction product on a surface of an electrode can be a conductor or an insulator depending on an electrode material or a liquid substance in contact with the electrode. The reaction product might change a current path, and might be a conductor to cause a short circuit or be an insulator to block the current path.

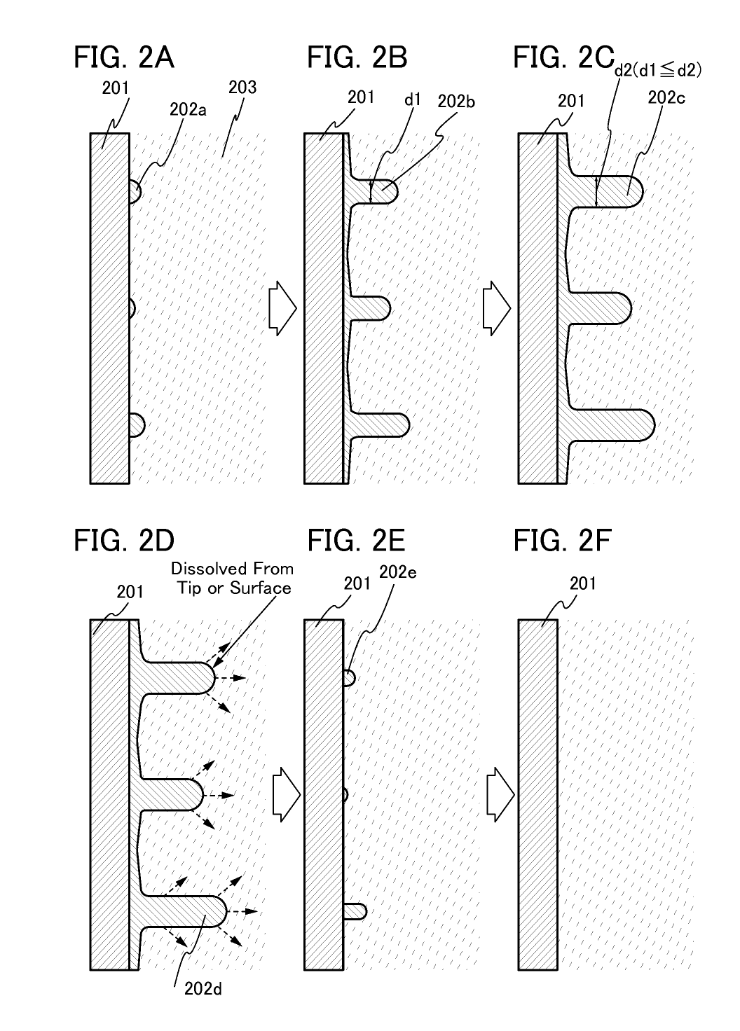

FIGS. 2A, 2B, and 2C are schematic cross-sectional views of reaction products 202a, 202b, and 202c, respectively, which are formed on a surface of an electrode 201, typically a negative electrode, through abnormal growth.

FIG. 2A is the schematic view of part of a battery including at least a positive electrode, a negative electrode, and an electrolytic solution.

Only the one electrode 201 and an electrolytic solution 203 in the vicinity of the electrode 201 are illustrated in FIGS. 2A to 2C for simplicity.

Here, in FIGS. 2A to 2F, the electrode 201 is either a positive electrode or a negative electrode, and description is made on the assumption that the electrode 201 is a negative electrode. FIG. 2A illustrates the state where a current is supplied between the negative electrode and a positive electrode (not illustrated) during a period T1 and the reaction products 202a are deposited on the electrode 201 that is the negative electrode so that the electrode 201 is dotted with the reaction products 202a.

FIG. 2B illustrates the state where a current is supplied between the negative electrode and the positive electrode during a period T2 (T2 is longer than T1). Projections of the reaction product 202b abnormally grow from the positions where they are deposited and the reaction product 202b is deposited on the entire surface of the electrode 201.

FIG. 2C illustrates the state where a current is supplied during a period T3 longer than the period T2. Projections of the reaction product 202c in FIG. 2C grow to be longer than the projections of the reaction product 202b in FIG. 2B in the direction perpendicular to the electrode 201. Note that although an example of a reaction product which grows in length in the direction perpendicular to the electrode 201 is illustrated in FIG. 2B, without particular limitation thereon, and the reaction product may grow and bend to have a bent portion or a plurality of bent portions. A thickness d2 of the projection of the reaction product 202c in FIG. 2C is larger than or equal to a thickness d1 of the projection of the reaction product 202b in FIG. 2B.

A reaction product is not uniformly deposited on the entire surface of the electrode as a current supply time passes. Once a reaction product is deposited, a reaction product is more likely to be deposited on the position where the reaction product has been deposited than on the other positions, and a larger amount of reaction product is deposited on the position and grows to be a large lump. The region where a large amount of reaction product has been deposited has higher conductivity than the other region. For this reason, a current is likely to concentrate at the region where the large amount of reaction product has been deposited, and the reaction product grows around the region faster than in the other region. Accordingly, a projection and a depression are formed by the region where a large amount of reaction product is deposited and the region where a small amount of reaction product is deposited, and the projection and the depression become larger as time goes by as illustrated in FIG. 2C. Finally, the large projection and depression cause severe degradation of the battery.

After the state in FIG. 2C, a signal to supply a current reverse to a current with which a reaction product is formed, a reverse pulse current here, is applied to dissolve the reaction product. FIG. 2D illustrates the state at the time immediately after the reverse pulse current is supplied. As shown by arrows in FIG. 2D, a reaction product 202d is dissolved from its tip or surface. This is because when the voltage is supplied, the potential gradient around the tip or the surface of the reaction product 202d becomes steep, so that the tip or the surface is likely to be preferentially dissolved.

The pulse voltage to supply a current reverse to a current with which a reaction product is formed is supplied in the state where the projection and depression due to non-uniform deposition of a reaction product are formed, whereby a current concentrates at the projection and the reaction product is dissolved. The reaction product dissolution means that a reaction product in a region in the electrode surface where a large amount of reaction product is deposited is dissolved to reduce the area of the region where the large amount of reaction product is deposited, preferably means that the electrode surface is returned to the state at the time before a reaction product is deposited on the electrode surface. Even when the electrode surface is not returned to the state at the time before a reaction product is deposited on the electrode surface, a significant effect can be provided by inhibiting an increase in the amount of reaction product to keep the amount small, or by reducing the size of the reaction product.

FIG. 2E illustrates a state in the middle of the dissolution of the reaction product by additionally supplying the reverse pulse current; the reaction product 202d is dissolved from its tip or surface to be the reaction product 202e smaller than the reaction product 202d.

Then, a signal to supply a current reverse to a current with which the reaction product is formed is applied, i.e., a reverse pulse current is supplied, one or more times, for example; thus, ideally, the surface of the electrode 201 can be returned to the state at the time before the reaction product is deposited on the surface of the electrode 201 as illustrated in FIG. 2F. Since a current flows from the right side to the left side in FIGS. 2A to 2F in charging, a reverse pulse current is supplied so as to flow in the direction opposite to the direction of the current flow (from the left side to the right side in FIGS. 2A to 2F). Specifically, one period during which the reverse pulse current is supplied is longer than or equal to 0.1 seconds and shorter than or equal to 3 minutes, typically longer than or equal to 3 seconds and shorter than or equal to 30 seconds.

A technical idea of one embodiment of the present invention is to utilize the mechanism of formation of a reaction product and the mechanism of dissolution of the reaction product. One embodiment of the present invention includes a first electrode and a second electrode, and includes at least an electrolytic solution between the first electrode and the second electrode. A reaction product, which grows from at least one point in a surface of the first electrode due to a current that flows between the first electrode and the second electrode, is dissolved from the tip or the surface of the reaction product by supplying a current reverse to the current. Note that the use of the mechanisms can provide a novel electronic device based on an extremely novel principle.

Another embodiment of the present invention is to apply a signal to supply a current reverse to a current with which a reaction product is formed more than once. That is, another embodiment of the present invention includes a first electrode and a second electrode, and includes at least an electrolytic solution between the first electrode and the second electrode. A reaction product, which grows from at least one point in a surface of the first electrode due to a current that flows between the first electrode and the second electrode, is dissolved from the tip or the surface of the reaction product by supplying a current reverse to the current, and then supply of the current reverse to the current after supply of the current that flows between the first electrode and the second electrode is repeated.

Another embodiment of the present invention is to make a period during which a signal to supply a current reverse to a current with which a reaction product is formed is applied shorter than a period during which the reaction product is formed. That is, another embodiment of the present invention includes a first electrode and a second electrode, and includes at least an electrolytic solution between the first electrode and the second electrode. A reaction product, which grows from at least one point in a surface of the first electrode due to a current that flows between the first electrode and the second electrode for a predetermined period, is dissolved from the tip or the surface of the reaction product by supplying a current reverse to the current for a period shorter than the predetermined period.

In addition, when the reaction product dissolves in the electrolytic solution at high speed, the state in FIG. 2D can be changed into the state in FIG. 2F even if the signal to supply a current reverse to a current with which the reaction product is formed is applied for a very short time.

Note that depending on conditions (e.g., pulse width, timing, and intensity) for applying the signal to supply a current reverse to a current with which a reaction product is formed, the state in FIG. 2D can be changed into the state in FIG. 2F in a short time by applying the signal even only once.

Although the negative electrode is described as an example in FIGS. 2A to 2F, without particular limitation thereon, the same effect can also be obtained in the case of using a positive electrode.

The degradation of a battery can be prevented or the degree of the degradation can be reduced by applying a signal to supply a current reverse to a current with which a reaction product is formed during charge or discharge.

One embodiment of the present invention is not limited to the mechanisms illustrated in FIGS. 2A to 2F. The other examples of the mechanisms are described below.

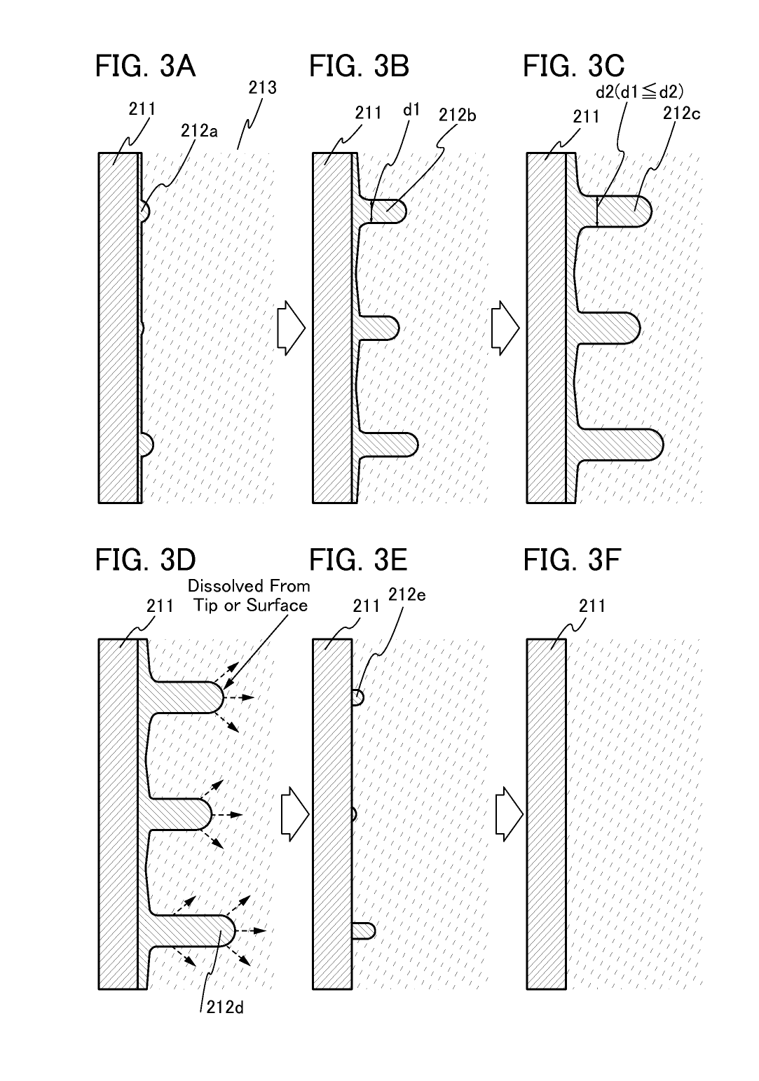

FIGS. 3A to 3F illustrate mechanisms different from those in FIGS. 2A to 2F in part of a process of generation (or growth) of a reaction product; the reaction product is deposited on an entire electrode surface and partly grows abnormally.

FIGS. 3A, 3B, and 3C are schematic cross-sectional views of reaction products 212a, 212b, and 212c, respectively, which are formed on a surface of an electrode 211, typically a surface of a negative electrode, through abnormal growth. Note that a space between a pair of electrodes is filled with an electrolytic solution 213.

FIG. 3A illustrates the state where a current is supplied between the negative electrode and a positive electrode (not illustrated) during the period T1 and the reaction product 212a is deposited on the entire surface of the electrode 211 that is the negative electrode and partly grows abnormally. Examples of the electrode 211 on which the reaction product 212a is deposited are graphite, a combination of graphite and graphene oxide, and titanium oxide.

FIG. 3B illustrates the state of the reaction product 212b which grows when a current is supplied between the negative electrode and the positive electrode during the period T2 (T2 is longer than T1). FIG. 3C illustrates the state of the reaction product 212c which grows due to a current flow during the period T3 that is longer than the period T2.

After the state in FIG. 3C, a signal to supply a current reverse to a current with which the reaction product is formed is applied to dissolve the reaction product. FIG. 3D illustrates the state at the time immediately after the signal to supply the current reverse to the current with which a reaction product 212d is formed is applied, e.g., a pulse voltage is supplied. As shown by arrows in FIG. 3D, the reaction product 212d is dissolved from its tip or surface.

FIG. 3E illustrates a state in the middle of the dissolution of the reaction product by additionally supplying the reverse pulse current; the reaction product 212d is dissolved from its tip or surface to be a reaction product 212e smaller than the reaction product 212d.

In this manner, one embodiment of the present invention can be applied regardless of the process of generation of the reaction product and the mechanism thereof. By applying a signal to supply a current reverse to a current with which the reaction product is formed one or more times, ideally, the surface of the electrode 211 can be returned to the initial state at the time before the reaction product is deposited on the surface of the electrode 211 as illustrated in FIG. 3F.

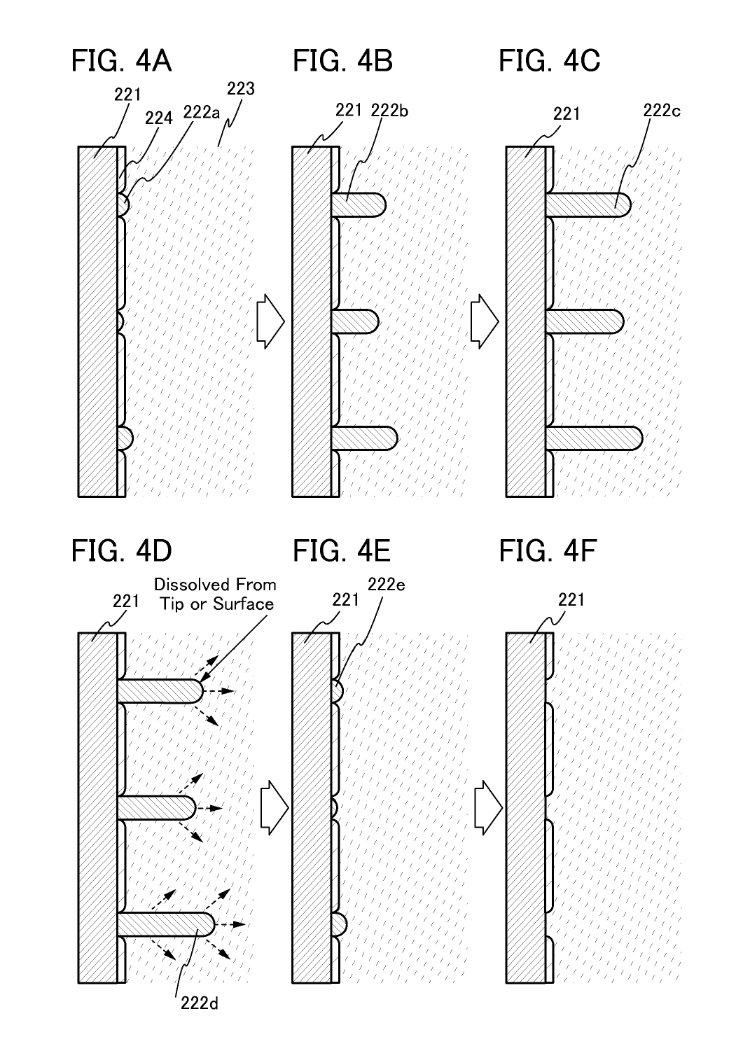

Unlike FIGS. 2A to 2F, FIGS. 4A to 4F are an example where a protective film is formed on the surface of the electrode 221 and illustrate a state where a reaction product is deposited in a region not covered with the protective film and abnormally grows.

FIGS. 4A to 4C are schematic cross-sectional views of reaction products 222a, 222b, and 222c which abnormally grows and are formed in a region of a surface of the electrode 221 (typically, a negative electrode) that is not covered with a protective film 224. Note that a space between a pair of electrodes is filled with an electrolytic solution 223. For the protective film 224, a single layer of a silicon oxide film, a niobium oxide film, or an aluminum oxide film or a stack including any of the films is used.

FIG. 4A illustrates the state where a current is supplied between the negative electrode and a positive electrode (not illustrated) during the period T1, and the reaction products 222a are deposited on exposed portions of the electrode 221 serving as the negative electrode and grow abnormally.

FIG. 4B illustrates the state of the reaction product 222b which grows when a current is supplied between the negative electrode and the positive electrode during the period T2 (T2 is longer than T1). FIG. 4C illustrates the state of the reaction product 222c which grows when a current is supplied during the period T3 longer than the period T2.

After the state in FIG. 4C, a signal to supply a current reverse to a current with which the reaction product is formed is applied to dissolve the reaction product. FIG. 4D illustrates the state at the time immediately after the signal to supply the current reverse to the current with which the reaction product is formed is applied. As shown by arrows in FIG. 4D, a reaction product 222d is dissolved from its tip or surface.

FIG. 4E illustrates the state where the reaction product is in the middle of the dissolution by additionally supplying the reverse pulse current; the reaction product 222d is dissolved from its tip or surface to be a reaction product 222e smaller than the reaction product 222d.

One embodiment of the present invention includes a first electrode, a protective film covering part of the first electrode, a second electrode, and an electrolytic solution between the first electrode and the second electrode. A reaction product, which grows due to a current that flows between the first electrode and the second electrode from a region of a surface of the first electrode which is not covered with the protective film, is dissolved by applying a signal to supply a current reverse to the current. Note that the use of the mechanisms illustrated in FIGS. 4A to 4F can provide a novel electronic device based on an extremely novel principle.

As described above, in the state illustrated in FIG. 2C, 3C, or 4C, a deposited reaction product, e.g., lithium or a whisker, can be dissolved by supplying a reverse pulse current as a signal to supply a current reverse to a charging current; thus, the surface of the negative electrode can be returned to a normal state. Further, a reverse pulse current is supplied before the deposited lithium is separated in charging, whereby the lithium is reduced in size or is dissolved; thus, separation of the lithium can be prevented.

When lithium metal is deposited in a negative electrode of a battery cell, for example, it causes a variety of defects in the battery cell, so that the reliability of the battery cell might be decreased. In one embodiment of the present invention, even if lithium metal is deposited in a negative electrode, it is dissolved or made stable by supplying a reverse pulse current while a battery cell is charged; thus, the reliability of the battery cell can be increased. Consequently, the capacity ratio of the battery cell can be increased, so that the size of the battery cell can be reduced.

In the power storage device 101 illustrated in FIGS. 1A and 1B, a plurality of battery cells which operate according to the above mechanisms are connected in series. Further, when the plurality of battery cells connected in series are used as a unit and the units are connected in parallel, the capacity of the power storage device 101 can be increased. Further, even when the power storage device 101 has high capacity and large volume, the power storage device 101 can be stored in an underfloor space surrounded by a base and a floor of a building. Since the power storage device 101 can be stored in the underfloor space 106, the power storage device 101 is not needed to be provided outdoors. When the power storage device 101 is stored in the underfloor space 106 as described above, the power storage device 101 can be prevented from being exposed to rain or the like, so that degradation of the power storage device 101 due to moisture can be prevented. Even when the outside air is at a low temperature (e.g., minus temperature range), degradation of the power storage device 101 can be suppressed because the power storage device 101 is provided indoors. Accordingly, the lifetime of the power storage device 101 can be further increased.

This embodiment can be freely combined with any of the other embodiments.

### Embodiment 2

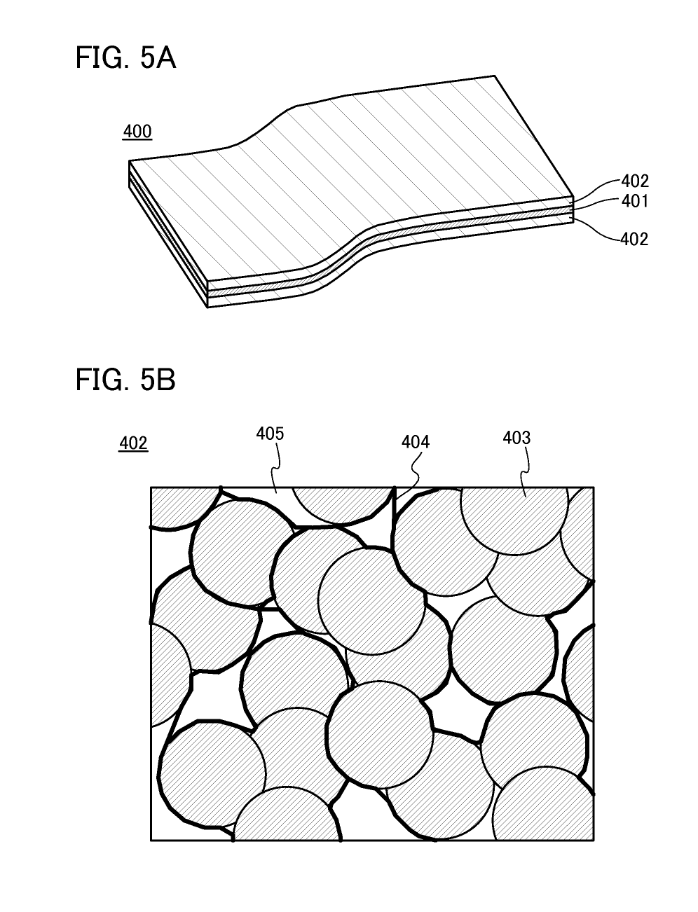

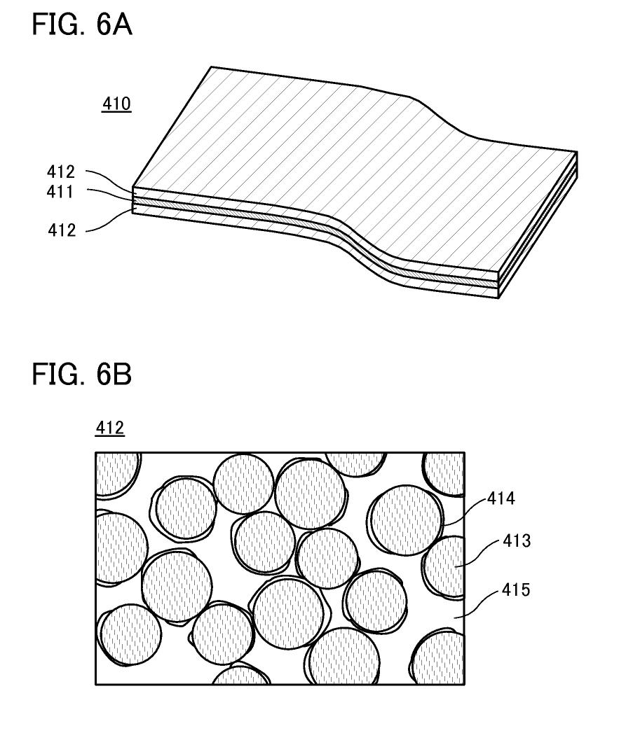

In this embodiment, the battery cell described in Embodiment 1 and a manufacturing method thereof are described with reference to FIGS. 5A and 5B and FIGS. 6A and 6B.

First, a positive electrode of a battery cell is described with reference to FIGS. 5A and 5B.

A positive electrode 400 includes a positive electrode current collector 401 and a positive electrode active material layer 402 formed over the positive electrode current collector 401 by a coating method, a CVD method, a sputtering method, or the like, for example. Although an example of providing the positive electrode active material layer 402 on both surfaces of the positive electrode current collector 401 with a sheet shape (or a strip-like shape) is illustrated in FIG. 5A, one embodiment of the present invention is not limited to this example. The positive electrode active material layer 402 may be provided on one of the surfaces of the positive electrode current collector 401. Further, although the positive electrode active material layer 402 is provided entirely over the positive electrode current collector 401 in FIG. 5A, one embodiment of the present invention is not limited thereto. The positive electrode active material layer 402 may be provided over part of the positive electrode current collector 401. For example, a structure may be employed in which the positive electrode active material layer 402 is not provided in a portion where the positive electrode current collector 401 is connected to a positive electrode tab.

The positive electrode current collector 401 can be formed using a material that has high conductivity and is not alloyed with a carrier ion of lithium or the like, such as a metal typified by stainless steel, gold, platinum, zinc, iron, copper, aluminum, or titanium, or an alloy thereof. The positive electrode current collector 401 can be formed using an aluminum alloy to which an element which improves heat resistance, such as silicon, titanium, neodymium, scandium, or molybdenum, is added. Alternatively, the positive electrode current collector 401 may be formed using a metal element which forms silicide by reacting with silicon. Examples of the metal element which forms silicide by reacting with silicon include zirconium, titanium, hafnium, vanadium, niobium, tantalum, chromium, molybdenum, tungsten, cobalt, and nickel. The positive electrode current collector 401 can have a foil-like shape, a plate-like shape (a sheet-like shape), a net-like shape, a punching-metal shape, an expanded-metal shape, or the like, as appropriate. The positive electrode current collector 401 preferably has a thickness of greater than or equal to 10 μm and less than or equal to 30 μm.

FIG. 5B is a schematic view illustrating the longitudinal cross-sectional view of the positive electrode active material layer 402. The positive electrode active material layer 402 includes particles of a positive electrode active material 403, graphene 404 as a conductive additive, and a binder 405 (binding agent).

Examples of the conductive additive are acetylene black (AB), ketjen black, graphite (black lead) particles, and carbon nanotubes in addition to graphene described later. Here, the positive electrode active material layer 402 using the graphene 404 is described as an example.

The positive electrode active material 403 is in the form of particles made of secondary particles having average particle diameter or particle diameter distribution, which is obtained in such a way that material compounds are mixed at a predetermined ratio and baked and the resulting baked product is crushed, granulated, and classified by an appropriate means. Therefore, the positive electrode active material 403 is schematically illustrated as spheres in FIG. 5B; however, the shape of the positive electrode active material 403 is not limited to this shape.

As the positive electrode active material 403, a material into/from which lithium ions can be inserted and extracted can be used. For example, a material with an olivine crystal structure, a layered rock-salt crystal structure, or a spinel crystal structure can be given.

As the material with an olivine crystal structure, a composite oxide represented by a general formula LiMPO₄ (M is one or more of Fe(II), Mn(II), Co(II), and Ni(II)) can be given. Typical examples of the general formula LiMPO₄ are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly has properties necessary for the positive electrode active material, such as safety, stability, high capacity density, high potential, and the existence of lithium ions which can be extracted in initial oxidation (charge).

Examples of the material with a layered rock-salt crystal structure are lithium cobalt oxide (LiCoO₂), LiNiO₂, LiMnO₂, Li₂MnO₃, a NiCo-based material (general formula: LiNiₓCo₁₋ₓO₂ (0<x<1)) such as LiNi_{0.8}Co_{0.2}O₂, a NiMn-based material (general formula: LiNiₓMn₁₋ₓO₂ (0<x<1)) such as LiNi_{0.5}Mn_{0.5}O₂, a NiMnCo-based material (also referred to as NMC, and a general formula: LiNiₓMn_{y}Co_{1-x-y}O₂ (x>0, y>0, x+y<1)) such as LiNi_{1/3}Mn_{1/3}CO_{1/3}O₂, Li(Ni_{0.8}Co_{0.15}Al_{0.05})O₂, and Li₂MnO₃-LiMO₂ (M=Co, Ni, or Mn).

LiCoO₂ is particularly preferable because it has high capacity, is more stable in the air than LiNiO₂, and is more thermally stable than LiNiO₂, for example.

Examples of a material with a spinel crystal structure are LiMn₂O₄, Li₁₊ₓMn₂₋ₓO₄, Li(MnAl)₂O₄, and LiMn_{1.5}Ni_{0.50}O₄.

It is preferable to add a small amount of lithium nickel oxide (LiNiO₂ or LiNi₁₋ₓMO₂ (M=Co, Al, or the like)) to a material with a spinel crystal structure which contains manganese such as LiMn₂O₄ because advantages such as minimization of the elution of manganese and the decomposition of an electrolytic solution can be obtained.

Alternatively, a composite oxide represented by a general formula Li(₂₋ⱼ)MSiO₄ (M is one or more of Fe(II), Mn(II), Co(II), and Ni(II), 0≦j≦2) can be used as the positive electrode active material. Typical examples of the general formula Li(₂₋ⱼ)MSiO₄ are Li(₂₋ⱼ)FeSiO₄, Li(₂₋ⱼ)NiSiO₄, Li(₂₋ⱼ)CoSiO₄, Li(₂₋ⱼ)MnSiO₄, Li(₂₋ⱼ)FeₖNiᵢSiO₄, Li(₂₋ⱼ)FeₖCoᵢSiO₄, Li(₂₋ⱼ)FeₖMnᵢSiO₄, Li(₂₋ⱼ)NiₖCoᵢSiO₄, Li(₂₋ⱼ)NiₖMnᵢSiO₄ (k+l≦1, 0<k<1, and 0<l<1), Li(₂₋ⱼ)FeₘNiₙCo_{g}SiO₄, Li(₂₋ⱼ)FeₘNiₙMn_{q}SiO₄, Li(₂₋ⱼ)NiₘCoₙMn_{q}SiO₄ (m+n+q≦1, 0<m<1, 0<n<1, and 0<q<1), and Li(₂₋ⱼ)FeᵣNiₛCoₜMnᵤSiO₄ (r+s+t+u≦1, 0<r<1, 0<s<1, 0<t<1, and 0<u<1).

Still alternatively, a nasicon compound represented by a general formula AₓM₂(XO₄)₃ (A=Li, Na, or Mg, M=Fe, Mn, Ti, V, Nb, or Al, X=S, P, Mo, W, As, or Si) can be used as the positive electrode active material. Examples of the nasicon compound are Fe₂(MnO₄)₃, Fe₂(SO₄)₃, and Li₃Fe₂(PO₄)₃. Further alternatively, a compound represented by a general formula Li₂MPO₄F, Li₂MP₂O₇, or Li₅MO₄ (M=Fe or Mn), a perovskite fluoride such as NaF₃ or FeF₃, a metal chalcogenide (a sulfide, a selenide, or a telluride) such as TiS₂ or MoS₂, a material with an inverse spinel crystal structure such as LiMVO₄, a vanadium oxide (V₂O₅, V₆O₁₃, LiV₃O₈, or the like), a manganese oxide, an organic sulfur, or the like can be used as the positive electrode active material.

In the case where carrier ions are alkali metal ions other than lithium ions, or alkaline-earth metal ions, the positive electrode active material 403 may contain, instead of lithium in the compound and the oxide, an alkali metal (e.g., sodium or potassium), an alkaline-earth metal (e.g., calcium, strontium, barium, beryllium, or magnesium).

Note that although not illustrated, a carbon layer may be provided on a surface of the positive electrode active material 403. With a carbon layer, conductivity of an electrode can be increased. The positive electrode active material 403 can be coated with the carbon layer by mixing a carbohydrate such as glucose at the time of baking the positive electrode active material.

In addition, the graphene 404 which is added to the positive electrode active material layer 402 as a conductive additive can be formed by performing reduction treatment on graphene oxide.

Here, graphene in this specification and the like include single-layer graphene and multilayer graphene including two to a hundred layers. Single-layer graphene refers to a sheet of one atomic layer of carbon molecules having π bonds. Graphene oxide refers to a compound formed by oxidation of such graphene. Note that when oxygen contained in graphene oxide is released to form graphene, oxygen contained in graphene oxide is not entirely released and part of oxygen remains in graphene. When graphene contains oxygen, the ratio of oxygen measured by XPS in graphene is higher than or equal to 2 atomic % and lower than or equal to 20 atomic %, preferably higher than or equal to 3 atomic % and lower than or equal to 15 atomic %.

In the case where graphene is multilayer graphene and is formed by reducing graphene oxide here, the interlayer distance of graphene is greater than or equal to 0.34 nm and less than or equal to 0.5 nm, preferably greater than or equal to 0.38 nm and less than or equal to 0.42 nm, more preferably greater than or equal to 0.39 nm and less than or equal to 0.41 nm. In general graphite, the interlayer distance between single-layer graphenes is 0.34 nm. Since the interlayer distance between the graphenes used for the power storage device of one embodiment of the present invention is longer than that in general graphite, carrier ions can easily transfer between layers of the graphenes in the multilayer graphene.

Graphene oxide can be formed by an oxidation method called a Hummers method, for example.

The Hummers method is as follows: a sulfuric acid solution of potassium permanganate, a hydrogen peroxide solution, and the like are mixed into graphite powder to cause oxidation reaction; thus, a dispersion liquid including graphite oxide is formed. Through the oxidation of carbon of graphite, functional groups such as an epoxy group, a carbonyl group, a carboxyl group, or a hydroxyl group are bonded in graphite oxide. Accordingly, the interlayer distance between a plurality of graphenes in graphite oxide is longer than the interlayer distance in graphite, so that graphite oxide can be easily separated into thin pieces by interlayer separation. Then, ultrasonic vibration is applied to the mixed solution containing graphite oxide, so that graphite oxide whose interlayer distance is long can be cleaved to separate graphene oxide and to form a dispersion liquid containing graphene oxide. A solvent is removed from the dispersion liquid containing graphene oxide, so that powdery graphene oxide can be obtained.

Note that the method for forming graphene oxide is not limited to the Hummers method using a sulfuric acid solution of potassium permanganate; for example, the Hummers method using nitric acid, potassium chlorate, nitric acid sodium, potassium permanganate, or the like or a method for forming graphene oxide other than the Hummers method may be employed as appropriate.

Graphite oxide may be separated into thin pieces by application of ultrasonic vibration, by irradiation with microwaves, radio waves, or thermal plasma, or by application of physical stress.

The formed graphene oxide includes an epoxy group, a carbonyl group, a carboxyl group, a hydroxyl group, or the like. In graphene oxide, oxygen in a functional group is negatively charged in a polar solvent typified by NMP (also referred to as N-methylpyrrolidone, 1-methyl-2-pyrrolidone, N-methyl-2-pyrrolidone, or the like); therefore, while interacting with NMP, the graphene oxide repels other graphene oxides and is hardly aggregated. Accordingly, in a polar solvent, graphene oxides can be easily dispersed uniformly.

The length of one side (also referred to as a flake size) of graphene oxide is preferably greater than or equal to 50 nm and less than or equal to 100 μm, more preferably greater than or equal to 800 nm and less than or equal to 20 μm.

As in the cross-sectional view of the positive electrode active material layer 402 in FIG. 5B, the plurality of particles of the positive electrode active material 403 are coated with the plurality of graphenes 404. The sheet-like graphene 404 is connected to the plurality of particles of the positive electrode active material 403. In particular, since the graphenes 404 are in the form of a sheet, surface contact can be made in such a way that part of surfaces of the particles of the positive electrode active material 403 is wrapped with the graphenes 404. Unlike a conductive additive in the form of particles, such as acetylene black, which makes point contact with a positive electrode active material, the graphenes 404 are capable of surface contact with low contact resistance; accordingly, the electron conductivity of the particles of the positive electrode active material 403 and the graphenes 404 can be improved without an increase in the amount of conductive additives.

Further, surface contact is made between the plurality of graphenes 404. This is because graphene oxides with extremely high dispersibility in a polar solvent are used for the formation of the graphenes 404. A solvent is removed by volatilization from a dispersion medium including graphene oxides uniformly dispersed and graphene oxides are reduced to give graphenes; hence, the graphenes 404 remaining in the positive electrode active material layer 402 are partly overlapped with each other and dispersed such that surface contact is made, thereby forming a path for electron conduction.

Further, some pieces of the graphene 404 are arranged three-dimensionally between the particles of the positive electrode active material 403. Furthermore, the graphenes 404 are extremely thin films (sheets) made of a single layer of carbon molecules or stacked layers thereof and hence are over and in contact with part of the surfaces of the particles of the positive electrode active material 403 in such a way as to trace these surfaces. A portion of the graphenes 404 which is not in contact with the positive electrode active material 403 is warped between the particles of the positive electrode active material 403 and crimped or stretched.

Consequently, the plurality of graphenes 404 form a network for electron conduction in the positive electrode 400. Thus, a path for electric conduction between the particles of the positive electrode active material 403 is maintained. As described above, graphenes whose raw material is graphene oxide and which are formed by reduction performed after a paste is formed are employed as a conductive additive, so that the positive electrode active material layer 402 with high electron conductivity can be formed.

The proportion of the positive electrode active material 403 in the positive electrode active material layer 402 can be increased because the added amount of conductive additives is not necessarily increased in order to increase contact points between the positive electrode active material 403 and the graphenes 404. Accordingly, the discharge capacity of the battery cell can be increased.

The average particle diameter of primary particles of the particles of the positive electrode active material 403 is preferably less than or equal to 500 nm, more preferably greater than or equal to 50 nm and less than or equal to 500 nm. To make surface contact with the plurality of particles of the positive electrode active material 403, the graphenes 404 have sides each having a length of greater than or equal to 50 nm and less than or equal to 100 μm, preferably greater than or equal to 800 nm and less than or equal to 20 μm.

As the binder 405 (binding agent) included in the positive electrode active material layer 402, polyvinylidene fluoride (PVDF) as a typical example, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose, or the like can be used.

The above positive electrode active material layer 402 preferably includes the positive electrode active material 403 at greater than or equal to 90 wt % and less than or equal to 94 wt %, the graphenes 404 as a conductive additive at greater than or equal to 1 wt % and less than or equal to 5 wt %, and the binder at greater than or equal to 1 wt % and less than or equal to 5 wt % with respect to the total weight of the positive electrode active material layer 402.

Next, a negative electrode of a battery cell is described with reference to FIGS. 6A and 6B.

A negative electrode 410 includes a negative electrode current collector 411 and a negative electrode active material layer 412 formed over the negative electrode current collector 411 by a coating method, a CVD method, a sputtering method, or the like, for example. Although an example of providing the negative electrode active material layer 412 on both surfaces of the negative electrode current collector 411 with a sheet shape (or a strip-like shape) is illustrated in FIG. 6A, one embodiment of the present invention is not limited to this example. The negative electrode active material layer 412 may be provided on one of the surfaces of the negative electrode current collector 411. Further, although the negative electrode active material layer 412 is provided entirely over the negative electrode current collector 411 in FIG. 6A, one embodiment of the present invention is not limited thereto. The negative electrode active material layer 412 may be provided over part of the negative electrode current collector 411. For example, a structure may be employed in which the negative electrode active material layer 412 is not provided in a portion where the negative electrode current collector 411 is connected to a negative electrode tab.

The negative electrode current collector 411 can be formed using a material, which has high conductivity and is not alloyed with carrier ions such as lithium ions, e.g., a metal typified by stainless steel, gold, platinum, zinc, iron, copper, or titanium, or an alloy thereof. Alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The negative electrode current collector 411 can have a foil-like shape, a plate-like shape (sheet-like shape), a net-like shape, a punching-metal shape, an expanded-metal shape, or the like, as appropriate. The negative electrode current collector 411 preferably has a thickness of greater than or equal to 10 μm and less than or equal to 30 μm.

FIG. 6B is a schematic view of part of a cross-section of the negative electrode active material layer 412. Although an example of the negative electrode active material layer 412 including a negative electrode active material 413 and a binder 415 (binding agent) is shown here, one embodiment of the present invention is not limited to this example. It is sufficient that the negative electrode active material layer 412 includes at least the negative electrode active material 413.

As the negative electrode active material 413, a material with which lithium can be dissolved and precipitated or a material into/from which lithium ions can be inserted and extracted can be used; for example, a lithium metal, a carbon-based material, an alloy-based material, or the like can be used.

The lithium metal is preferable because of its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (0.1 V to 0.3 V vs. Li/Li⁺) when lithium ions are inserted into the graphite (when a lithium-graphite intercalation compound is formed). For this reason, a lithium ion battery can have a high operating voltage. In addition, graphite is preferable because of its advantages such as relatively high capacity per unit volume, small volume expansion, low cost, and safety greater than that of a lithium metal.

For the negative electrode active material 413, an alloy-based material which enables charge-discharge reaction by alloying and dealloying reaction with lithium can be used. In the case where carrier ions are lithium ions, for example, a material containing at least one of Al, Si, Ge, Sn, Pb, Sb, Bi, Ag, Zn, Cd, In, Ga, and the like can be given. Such elements have higher capacity than carbon. In particular, silicon has a significantly high theoretical capacity of 4200 mAh/g. For this reason, silicon is preferably used as the negative electrode active material 413. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, SbSn, and the like.

Alternatively, as the negative electrode active material 413, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Still alternatively, as the negative electrode active material 413, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of high charge and discharge capacity (900 mAh/g and 1890 mAh/cm³).

A nitride containing lithium and a transition metal is preferably used, in which case lithium ions are contained in the negative electrode active material 413 and thus the negative electrode active material 413 can be used in combination with a material for a positive electrode active material which does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material which causes a conversion reaction can be used as the negative electrode active material 413; for example, a transition metal oxide which does not cause an alloy reaction with lithium, such as cobalt oxide (CoO), nickel oxide (NiO), or iron oxide (FeO), may be used. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as the positive electrode active material 403 because of its high potential.

Although the negative electrode active material 413 is illustrated as a particulate substance in FIG. 6B, the shape of the negative electrode active material 413 is not limited thereto. The negative electrode active material 413 can have a given shape such as a plate shape, a rod shape, a cylindrical shape, a powder shape, or a flake shape. Further, the negative electrode active material 413 may have unevenness or fine unevenness on its surface, or may be porous.

The negative electrode active material layer 412 may be formed by a coating method in the following manner: a conductive additive (not illustrated) or a binding agent is added to the negative electrode active material 413 to form a negative electrode paste; and the negative electrode paste is applied onto the negative electrode current collector 411 and dried.

Note that the negative electrode active material layer 412 may be predoped with lithium. The negative electrode active material layer 412 may be predoped in such a manner that a lithium layer is formed on a surface of the negative electrode active material layer 412 by a sputtering method. Alternatively, lithium foil is provided on the surface of the negative electrode active material layer 412, whereby the negative electrode active material layer 412 can be predoped with lithium.

Further, graphene (not illustrated) is preferably formed on the surface of the negative electrode active material 413. For example, in the case of using silicon as the negative electrode active material 413, the volume of silicon is greatly changed due to occlusion and release of carrier ions in charge-discharge cycles. Thus, adhesion between the negative electrode current collector 411 and the negative electrode active material layer 412 is decreased, resulting in degradation of battery characteristics caused by charge and discharge. In view of this, graphene is preferably formed on the surface of the negative electrode active material 413 containing silicon because even when the volume of silicon is changed in charge-discharge cycles, decrease in adhesion between the negative electrode current collector 411 and the negative electrode active material layer 412 can be regulated, which makes it possible to reduce degradation of battery characteristics.

Graphene formed on the surface of the negative electrode active material 413 can be formed by reducing graphene oxide in a manner similar to that of the method for forming the positive electrode. As graphene oxide, the above graphene oxide can be used.

Further, a film 414 of oxide or the like may be formed on the surface of the negative electrode active material 413. A coating film formed by decomposition of an electrolytic solution or the like in charging cannot release electric charges used at the time of forming the coating film, and therefore forms irreversible capacity. In contrast, the film 414 of oxide or the like provided on the surface of the negative electrode active material 413 in advance can reduce or prevent generation of irreversible capacity.

As the film 414 covering the negative electrode active material 413, an oxide film of any one of niobium, titanium, vanadium, tantalum, tungsten, zirconium, molybdenum, hafnium, chromium, aluminum, and silicon or an oxide film containing any one of these elements and lithium can be used. The film 414 is much denser than a conventional film formed on a surface of a negative electrode due to a decomposition product of an electrolytic solution.

For example, niobium oxide (Nb₂O₅) has a low electric conductivity of 10⁻⁹ S/cm and a high insulating property. For this reason, a niobium oxide film inhibits electrochemical decomposition reaction between the negative electrode active material and the electrolytic solution. On the other hand, niobium oxide has a lithium diffusion coefficient of 10⁻⁹ cm²/sec and high lithium ion conductivity. Therefore, niobium oxide can transmit lithium ions.

A sol-gel method can be used to coat the negative electrode active material 413 with the film 414, for example. The sol-gel method is a method for forming a thin film in such a manner that a solution of metal alkoxide, a metal salt, or the like is changed into a gel, which has lost its fluidity, by hydrolysis reaction and polycondensation reaction and the gel is baked. Since a thin film is formed from a liquid phase in the sol-gel method, raw materials can be mixed uniformly on the molecular scale. For this reason, by adding a negative electrode active material such as graphite to a raw material of the metal oxide film which is a solvent, the active material can be easily dispersed into the gel. In such a manner, the film 414 can be formed on the surface of the negative electrode active material 413.

The use of the film 414 can prevent a decrease in the capacity of the power storage device.

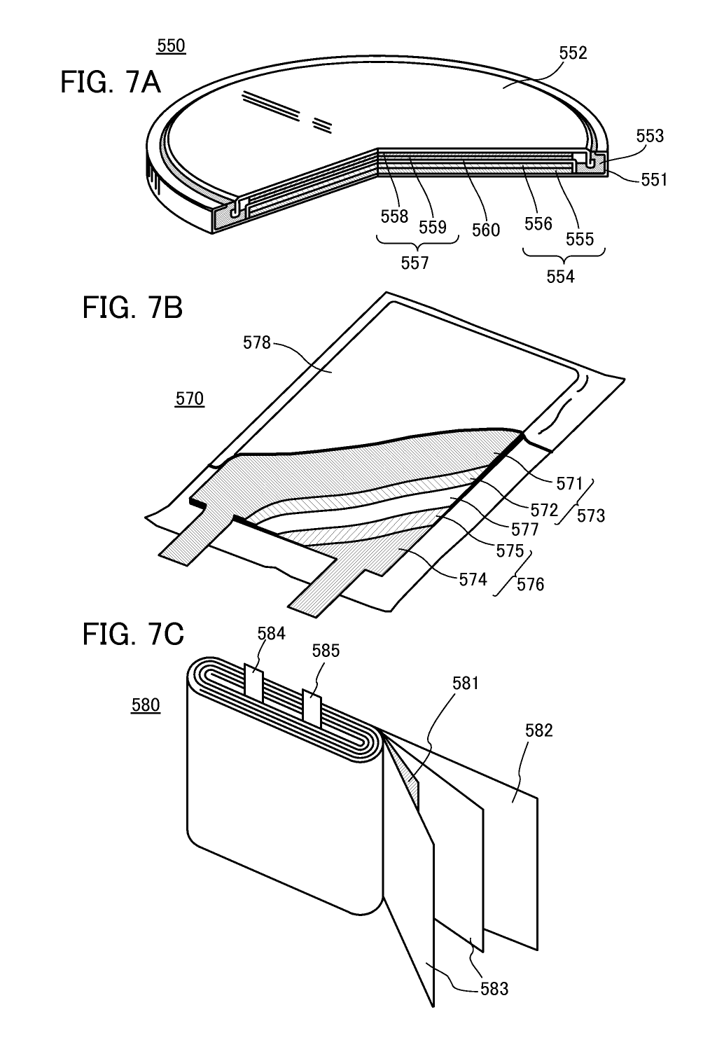

Next, a structure of a battery cell which can be used for a power storage device is described with reference to FIGS. 7A to 7C.

FIG. 7A is an external view of a coin-type (single-layer flat type) lithium-ion battery cell, part of which illustrates a cross-sectional view of the coin-type lithium-ion battery cell.

In a coin-type battery cell 550, a positive electrode can 551 serving also as a positive electrode terminal and a negative electrode can 552 serving also as a negative electrode terminal are insulated and sealed with a gasket 553 formed of polypropylene or the like. A positive electrode 554 includes a positive electrode current collector 555 and a positive electrode active material layer 556 which is provided to be in contact with the positive electrode current collector 555. A negative electrode 557 includes a negative electrode current collector 558 and a negative electrode active material layer 559 which is provided to be in contact with the negative electrode current collector 558. A separator 560 and an electrolytic solution (not illustrated) are included between the positive electrode active material layer 556 and the negative electrode active material layer 559.

The negative electrode 557 includes the negative electrode current collector 558 and the negative electrode active material layer 559. The positive electrode 554 includes the positive electrode current collector 555 and the positive electrode active material layer 556.

For the positive electrode 554, the negative electrode 557, the separator 560, and the electrolytic solution, the above-described members can be used.

For the positive electrode can 551 and the negative electrode can 552, a metal having corrosion resistance to an electrolytic solution, such as nickel, aluminum, or titanium, an alloy of such a metal, or an alloy of such a metal and another metal (e.g., stainless steel or the like) can be used. Alternatively, the positive electrode can 551 and the negative electrode can 552 are preferably covered with nickel, aluminum, or the like in order to prevent corrosion caused by the electrolytic solution. The positive electrode can 551 and the negative electrode can 552 are electrically connected to the positive electrode 554 and the negative electrode 557, respectively.

The negative electrode 557, the positive electrode 554, and the separator 560 are immersed in the electrolytic solution. Then, as illustrated in FIG. 7A, the positive electrode can 551, the positive electrode 554, the separator 560, the negative electrode 557, and the negative electrode can 552 are stacked in this order with the positive electrode can 551 positioned at the bottom, and the positive electrode can 551 and the negative electrode can 552 are subjected to pressure bonding with the gasket 553 interposed therebetween. In such a manner, the coin-type battery cell 550 is manufactured.

Further, for example, it is preferable that a graphite electrode be used as the negative electrode 557 of the battery cell 550 and lithium iron phosphate (LiFePO₄) be used for the positive electrode 554 of the battery cell 550. In that case, the safety of the battery cell 550 and the safety of the power storage device 101 including the battery cell 550 can be increased.

Next, an example of a laminated battery cell is described with reference to FIG. 7B. In FIG. 7B, a structure inside the laminated battery cell is partly exposed for convenience.

A laminated battery cell 570 illustrated in FIG. 7B includes a positive electrode 573 including a positive electrode current collector 571 and a positive electrode active material layer 572, a negative electrode 576 including a negative electrode current collector 574 and a negative electrode active material layer 575, a separator 577, an electrolytic solution (not illustrated), and an exterior body 578. The separator 577 is provided between the positive electrode 573 and the negative electrode 576 in the exterior body 578. The exterior body 578 is filled with the electrolytic solution. Although the one positive electrode 573, the one negative electrode 576, and the one separator 577 are used in FIG. 7B, the battery cell may have a stacked-layer structure in which positive electrodes and negative electrodes are alternately stacked and separated by separators.

For the positive electrode, the negative electrode, the separator, and the electrolytic solution (an electrolyte and a solvent), the above-described members can be used.

In the laminated battery cell 570 illustrated in FIG. 7B, the positive electrode current collector 571 and the negative electrode current collector 574 also serve as terminals (tabs) for an electrical contact with the outside. For this reason, each of the positive electrode current collector 571 and the negative electrode current collector 574 is arranged so that part of the positive electrode current collector 571 and part of the negative electrode current collector 574 are exposed outside the exterior body 578.

As the exterior body 578 in the laminated battery cell 570, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of the electrolytic solution and a gas can be blocked and an insulating property and resistance to the electrolytic solution can be obtained.

Next, an example of a rectangular battery cell is described with reference to FIG. 7C. A wound body 580 illustrated in FIG. 7C includes a negative electrode 581, a positive electrode 582, and a separator 583. The wound body 580 is obtained by winding a sheet of a stack in which the negative electrode 581 overlaps with the positive electrode 582 with the separator 583 provided therebetween. The wound body 580 is covered with a rectangular sealed can or the like; thus, a rectangular battery cell is fabricated. Note that the number of stacks each including the negative electrode 581, the positive electrode 582, and the separator 583 may be determined as appropriate depending on capacity and an element volume which are required.

As in the cylindrical battery cell, in the rectangular battery cell, the negative electrode 581 is connected to a negative electrode tab (not illustrated) through one of a terminal 584 and a terminal 585, and the positive electrode 582 is connected to a positive electrode tab (not illustrated) through the other of the terminal 584 and the terminal 585.

As described above, although the coin-type battery cell, the laminated battery cell, and the rectangular battery cell are described as examples of the battery cell, battery cells having a variety of shapes can be used. Further, a structure in which a plurality of positive electrodes, a plurality of negative electrodes, and a plurality of separators are stacked or wound may be employed.

As the separator used for each of the battery cells illustrated in FIGS. 7A to 7C, a porous insulator such as cellulose, polypropylene (PP), polyethylene (PE), polybutene, nylon, polyester, polysulfone, polyacrylonitrile, polyvinylidene fluoride, or tetrafluoroethylene can be used. Alternatively, nonwoven fabric of a glass fiber or the like, or a diaphragm in which a glass fiber and a high-molecular fiber are mixed may be used.

The electrolytic solution used for each of the battery cells illustrated in FIGS. 7A to 7C is preferably a nonaqueous solution (solvent) containing an electrolyte (solute).

As a solvent for the electrolytic solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled high-molecular material is used as the solvent of the electrolytic solution, safety against liquid leakage and the like is improved. Further, a battery cell can be thinner and more lightweight. Typical examples of the gelled high-molecular material include a silicone gel, an acrylic gel, an acrylonitrile gel, polyethylene oxide, polypropylene oxide, a fluorine-based polymer, and the like.

Alternatively, the use of one or more of ionic liquids (also referred to as room temperature molten salts) which are less likely to burn and volatilize as the solvent of the electrolytic solution can prevent the battery cell from exploding or catching fire even when the internal temperature increases due to an internal short circuit, overcharging, or the like. Thus, the safety of the battery cell can be increased. With the use of the ionic liquid as the solvent of the electrolytic solution, the battery cell can preferably operate even in a low temperature range (minus temperature range) as compared with the case where an organic solvent is used as the solvent of the electrolytic solution.

As an electrolyte dissolved in the above solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used, or two or more of these lithium salts can be used in an appropriate combination in an appropriate ratio.

Although the case where carrier ions are lithium ions in the above electrolyte is described, carrier ions other than lithium ions can be used. In the case where carrier ions are alkali metal ions other than lithium ions, or alkaline-earth metal ions, the electrolyte may contain, instead of lithium in the above lithium salts, an alkali metal (e.g., sodium or potassium), an alkaline-earth metal (e.g., calcium, strontium, barium, beryllium, or magnesium).

Instead of the electrolytic solution, a solid electrolyte including an inorganic material such as a sulfide-based inorganic material or an oxide-based inorganic material, or a solid electrolyte including a high-molecular material such as a polyethylene oxide (PEO)-based high-molecular material may alternatively be used. When the solid electrolyte is used, a separator is not necessary. Further, the battery can be entirely solidified; therefore, there is no possibility of liquid leakage and thus the safety of the battery cell is increased.

This embodiment can be freely combined with any of the other embodiments. With the use of a plurality of such battery cells, the power storage device 101 illustrated in FIGS. 1A and 1B can be fabricated. Specifically, battery cells which operate according to the mechanisms described in Embodiment 1 are connected in series. Further, when the plurality of battery cells connected in series are used as a unit and the units are connected in parallel, the capacity of the power storage device 101 can be increased. Further, even when the power storage device 101 has high capacity and large volume, the power storage device 101 can be stored in an underfloor space surrounded by a base and a floor of a building as illustrated in FIGS. 1A and 1B. Since the power storage device 101 can be stored in the underfloor space 106, the power storage device 101 is not needed to be provided outdoors. When the power storage device 101 is stored in the underfloor space 106 as described above, the power storage device 101 can be prevented from being exposed to rain or the like, so that degradation of the power storage device 101 due to moisture can be prevented. Even when the outside air is at a low temperature (e.g., minus temperature range), degradation of the power storage device 101 can be suppressed because the power storage device 101 is provided indoors. Accordingly, the lifetime of the power storage device 101 can be further increased.

### Embodiment 3

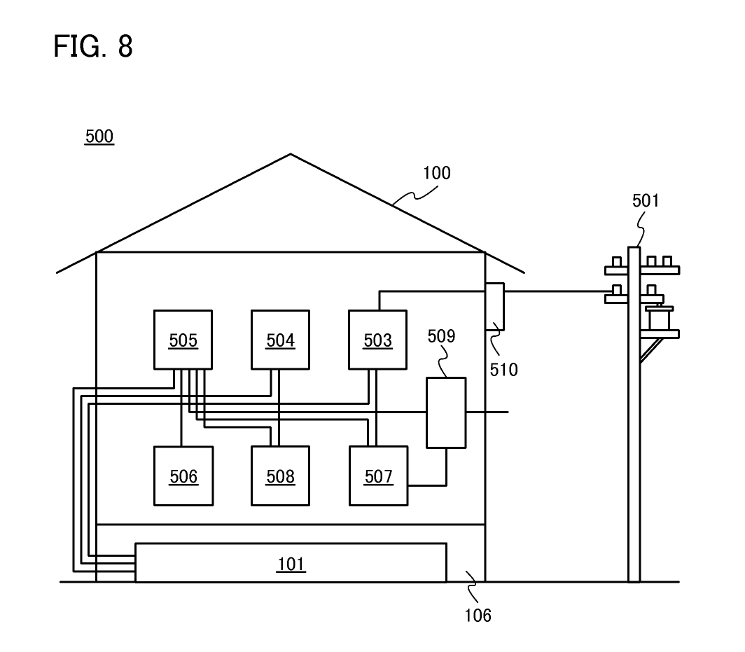

In this embodiment, an example of a power storage system 500 using a power storage device of the present invention is described with reference to FIG. 8.

As illustrated in FIG. 8, the power storage device 101 of one embodiment of the present invention is provided in the underfloor space 106 of the building 100. For example, the power storage device 101 of one embodiment of the present invention performs charging using an AC/DC converter in the night time and discharging using a DC/AC converter in the day time.

The power storage device 101 is electrically connected to a distribution board 503, a power storage distribution board 504, and a power storage controller 505.

Power is supplied to the distribution board 503 from the power storage device 101 and a commercial power source 501. Further, the commercial power source 501 supplies power to the distribution board 503 through a mounting portion 510 of a service wire. Moreover, the distribution board 503 is electrically connected to a general load 507, e.g., an electrical device such as a TV or a personal computer, to supply power thereto.

The power storage distribution board 504 supplies power to a power storage load 508 such as a refrigerator or an air conditioning apparatus.

Note that in this embodiment, an example where the distribution board 503 and the power storage distribution board 504 are used by loads is shown; however, power supply may be performed by one distribution board.

The power storage controller 505 always monitors states of the amount of power of the power storage device 101 and the like. In addition, the power storage controller 505 always monitors how power is supplied to the general load 507 and the power storage load 508.

The power storage controller 505 can select, depending on situations, supplying power from the power storage device 101 to the general load 507 or the power storage load 508 or supplying power from the commercial power source 501 to the general load 507 or the power storage load 508. For example, it is possible to select supplying power from the commercial power source 501 or supplying power from the power storage device 101 depending on day time or night time. In the case where power supply from the commercial power source 501 is stopped or suppressed, the power storage controller 505 controls power supply, e.g., switches to power supply from the power storage device 101.

For example, the power storage device 101 of one embodiment of the present invention performs charging using an AC/DC converter in the night time and discharging using a DC/AC converter (e.g., 50 Hz or 60 Hz) in the day time. The power storage device 101 is charged in the night time when the use amount of power is small, and is used indoors in the day time when the use amount of power is large; thus, power can be efficiently charged and used. Further, since the power storage device 101 is used in the day time when the usage charges of a commercial power source are high, the electricity charges are low and an economic merit can be obtained. Note that the frequency and voltage at the time of using power stored in the power storage device 101 can be set as appropriate depending on a region (country) where the power storage device 101 is used.

The state of the power storage device 101 monitored by the power storage controller 505 can be always checked using a TV or a personal computer through a router 509. Alternatively, it can be checked using a display 506 electrically connected to the power storage controller 505. Further alternatively, it can be checked using a portable electronic terminal such as a smartphone through the router 509.

Although not illustrated, the power storage device 101 may supply power to a charging station for an electric vehicle or the like.

By using the power storage device of one embodiment of the present invention in the above power storage system, people can live comfortably without inhibiting daily activities even if power supply equipment malfunctions or is partly broken or an electric company stops or suppresses power supply.

### Example 1

In this example, measurement results of cycle characteristics of a battery cell of one embodiment of the present invention are described. In this example, battery cells having four different proportions (capacity ratios; 85%, 80%, 60%, and 40%) of volume capacity of a positive electrode to volume capacity of a negative electrode as design conditions of the battery cells were measured.

First, structures and fabrication methods of coin-type battery cells used in this example are described. A battery cell fabricated to have a capacity ratio of 85% is referred to as a battery cell A, a battery cell fabricated to have a capacity ratio of 80% is referred to as a battery cell B, a battery cell fabricated to have a capacity ratio of 60% is referred to as a battery cell C, and a battery cell fabricated to have a capacity ratio of 40% is referred to as a battery cell D. Six for each battery cell were fabricated.

Positive electrodes used for the battery cells A to D were formed in the following manner. First, NMP was prepared as a dispersion medium, graphene oxide was dispersed in the NMP at 0.6 wt % as a conductive additive, lithium iron phosphate (which was coated with carbon; also referred to as C/LiFePO₄) was added at 91.4 wt % as a positive electrode active material, and then, the mixture was kneaded. After PVDF was added at 8 wt % as a binder to the mixture of the graphene oxide and the lithium iron phosphate, NMP was added as a dispersion medium and mixed, whereby a positive electrode paste was formed.

The positive electrode paste was applied to a positive electrode current collector (20-μm-thick aluminum), dried at 80° C. in an air atmosphere for 40 minutes, and then dried at 170° C. in a reduced atmosphere for 10 hours, whereby the positive electrode in which a positive electrode active material layer was formed over the positive electrode current collector was formed.

Here, the positive electrode used for the battery cell A included the positive electrode active material layer with a thickness of 58 μm, the positive electrode used for the battery cell B included the positive electrode active material layer with a thickness of 72 μm, the positive electrode used for the battery cell C included the positive electrode active material layer with a thickness of 55 μm, and the positive electrode used for the battery cell D included the positive electrode active material layer with a thickness of 61 μm.

An electrode sold by TAKUMI GIKEN Co., Ltd was used as each of negative electrodes of the battery cells A to C. Copper foil was used as a negative electrode current collector, mesocarbon microbeads with a grain diameter of 9 μm were used as a negative electrode active material, conductive graphite was used as a conductive additive, and PVDF was used as a binder. The weight ratio of the negative electrode active material to the conductive additive and the binder in a negative electrode active material layer was 79:14:7.

Here, the negative electrode used for the battery cell A included the negative electrode active material layer with a thickness of 65 μm, the negative electrode used for the battery cell B included the negative electrode active material layer with a thickness of 86 μm, and the negative electrode used for the battery cell C included the negative electrode active material layer with a thickness of 86 μm.

A negative electrode of the battery cell D was formed in the following manner. First, silicon ethoxide, ethyl acetoacetate, and toluene were mixed and stirred to form a Si(OEt)₄ toluene solution. At this time, the amount of the silicon ethoxide was determined so that the proportion of silicon oxide formed later to graphite (mesocarbon microbeads: MCMB, a diameter of 9 μm) which is the negative electrode active material was 1 wt %. The compounding ratio of this solution was as follows: the Si(OEt)₄ was 3.14×10⁻⁴ mol; the ethyl acetoacetate, 6.28×10⁻⁴ mol; and the toluene, 2 ml.

Next, the Si(OEt)₄ toluene solution to which graphite was added was stirred in a dry room. Then, the solution was held at 70° C. in a humid environment for 3 hours so that the Si(OEt)₄ in the Si(OEt)₄ toluene solution to which the graphite was added was hydrolyzed and condensed. In other words, the Si(OEt)₄ in the solution was made to react with moisture in the air, so that hydrolysis reaction gradually occurs, and the Si(OEt)₄ after the hydrolysis was condensed by dehydration reaction following the hydrolysis reaction. In such a manner, gelled silicon was attached to the surfaces of graphite particles to form a net-like structure of a C—O—Si bond.

Then, baking was performed at 500° C. in a nitrogen atmosphere for 3 hours, whereby graphite covered with silicon oxide was formed.

The graphite covered with 1 wt % of silicon oxide and PVDF as a binder were mixed to form a negative electrode paste, and the negative electrode paste was applied to a negative electrode current collector and dried, so that a negative electrode active material layer was formed. In this case, the weight ratio of the graphite to the PVDF was 90:10. As a solvent, NMP was used.

Here, the thickness of the negative electrode active material layer of the negative electrode used for the battery cell D was 106 μm.

In each of the battery cells A to D, an electrolytic solution in which EC and DEC were used as a nonaqueous solvent at a weight ratio of 3:7 and 1 M of LiPF₆ was dissolved as an electrolyte was used.

As a separator, a 25-μm-thick porous polypropylene film was used. The separator was impregnated with the above-described electrolytic solution.

A positive electrode can and a negative electrode can were formed of stainless steel (SUS). As a gasket, a spacer or a washer was used.

Next, the positive electrode can, the positive electrode, the separator, the negative electrode, the gasket, and the negative electrode can were stacked, and the positive electrode can and the negative electrode can were crimped to each other with a “coin cell crimper”. Thus, six for each of the coin-type battery cells A to D were fabricated.

Table 1 shows design conditions of the battery cells A to D. Note that a capacity ratio in Table 1 is a value obtained by dividing single-electrode theoretical capacity of the positive electrode by single-electrode theoretical capacity of the negative electrode.

TABLE 1

| | | | | | | Electrode | | Single-electrode | |
|---|---|---|---|---|---|---|---|---|---|
| | | | Conductive | | Thickness | density | Content | theoretical capacity | Capacity |
| | Electrode | Active material | additive | Binder | [μm] | [g/cm³] | [mg/cm²] | [mAh/cm²] | ratio |
| Battery | Positive | C/LiFePO₄ | GO | PVDF | 58 | 1.71 | 9.4 | 1.6 | 0.84 |
| cell A | electrode | | | | | | | | |
| | Content | 91.4 | 0.6 | 8 | | | | | |
| | percentage | | | | | | | | |
| | Negative | Graphene | Conductive | PVDF | 65 | 0.99 | 5.1 | 1.9 | |
| | electrode | | graphite | | | | | | |
| | Content | 79 | 14 | 7 | | | | | |
| | percentage | | | | | | | | |
| Battery | Positive | C/LiFePO₄ | GO | PVDF | 72 | 1.92 | 12.6 | 2.1 | 0.78 |
| cell B | electrode | | | | | | | | |
| | Content | 91.4 | 0.6 | 8 | | | | | |
| | percentage | | | | | | | | |
| | Negative | Graphene | Conductive | PVDF | 86 | 1.08 | 7.4 | 2.8 | |
| | electrode | | graphite | | | | | | |
| | Content | 79 | 14 | 7 | | | | | |
| | percentage | | | | | | | | |
| Battery | Positive | C/LiFePO₄ | GO | PVDF | 55 | 1.89 | 9.5 | 1.6 | 0.59 |
| cell C | electrode | | | | | | | | |
| | Content | 91.4 | 0.6 | 8 | | | | | |
| | percentage | | | | | | | | |
| | Negative | Graphene | Conductive | PVDF | 86 | 1.08 | 7.4 | 2.8 | |
| | electrode | | graphite | | | | | | |
| | Content | 79 | 14 | 7 | | | | | |
| | percentage | | | | | | | | |
| Battery | Positive | C/LiFePO₄ | GO | PVDF | 61 | 1.68 | 9.4 | 1.6 | 0.37 |
| cell D | electrode | | | | | | | | |
| | Content | 91.4 | 0.6 | 8 | | | | | |
| | percentage | | | | | | | | |
| | Negative | Graphene | AB | PVDF | 106 | 1.22 | 11.6 | 4.3 | |
| | electrode | (MCMB: 9 μm) | | | | | | | |
| | | Coated | | | | | | | |
| | Content | 90 | 0 | 10 | | | | | |
| | percentage | | | | | | | | |

In each of the battery cells A to D, the thicknesses of the negative electrode current collector, the positive electrode current collector, and the separator were 18 μm, 20 μm, and 25 μm, respectively.

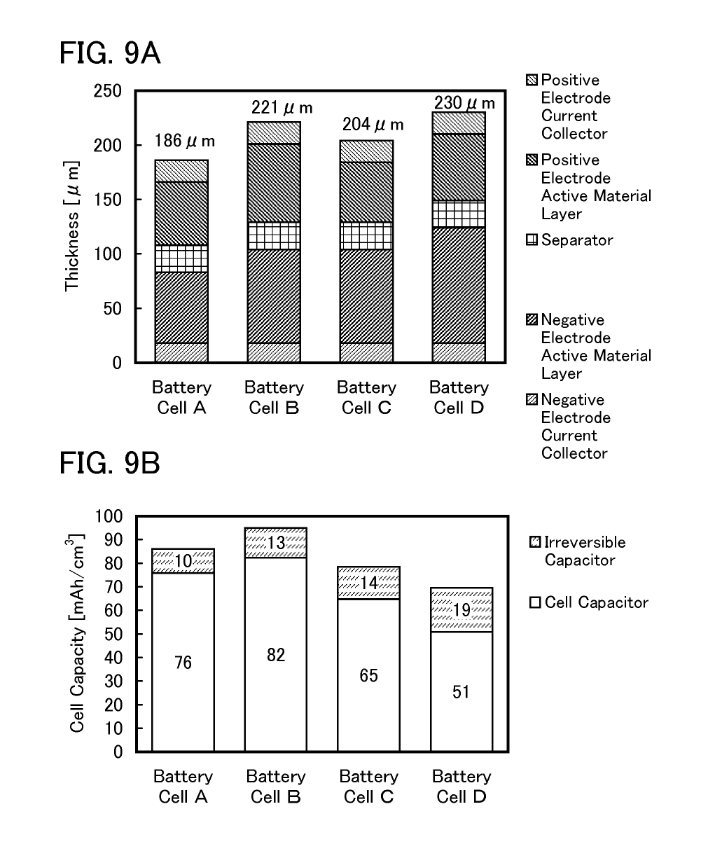

FIG. 9A shows the thicknesses of components, i.e., the negative electrode current collector, the negative electrode active material layer, the separator, the positive electrode active material layer, and the positive electrode current collector, of each of the battery cells A to D. FIG. 9B shows cell capacity obtained by calculation in each of the battery cells A to D. Note that in FIG. 9B, the irreversible capacity was calculated by dividing 10% of the single-electrode theoretical capacity of the negative electrode by the total thickness of the components. Further, the cell capacity was calculated in such a manner that the single-electrode theoretical capacity of the positive electrode was divided by the total thickness of the components and the irreversible capacity was subtracted.

Next, the cycle characteristics of the battery cells A to D were measured. In each of the battery cells A to D, a reverse pulse was input to three of the six battery cells and was not input to the others during charging.

In the case of inputting a reverse pulse to the battery cell in charging, the charging was performed at a charge rate of 1 C (170 mA/g) and was stopped when the constant current (CC) was 4.0 V. Further, a signal to supply a current reverse to a charging current was applied per certain amount of charged power (10 mAh/g). Discharging for a short period during the charging was performed at a discharge applied current rate of 1 C (170 mA/g) with a discharge applied length of 10 seconds. Discharging was performed at a discharge rate of 1 C and was stopped when the constant current (CC) was 2.0 V. The charging and the discharging were regarded as one cycle, and cycle characteristics were measured.

In the case of not inputting a reverse pulse to the battery cell in charging, the charging was performed at a charge rate of 1 C (170 mA/g) and was stopped when the constant current (CC) was 4.0 V. Discharging was performed at a discharge rate of 1 C and was stopped when the constant current (CC) was 2.0 V. The charging and the discharging were regarded as one cycle, and cycle characteristics were measured.

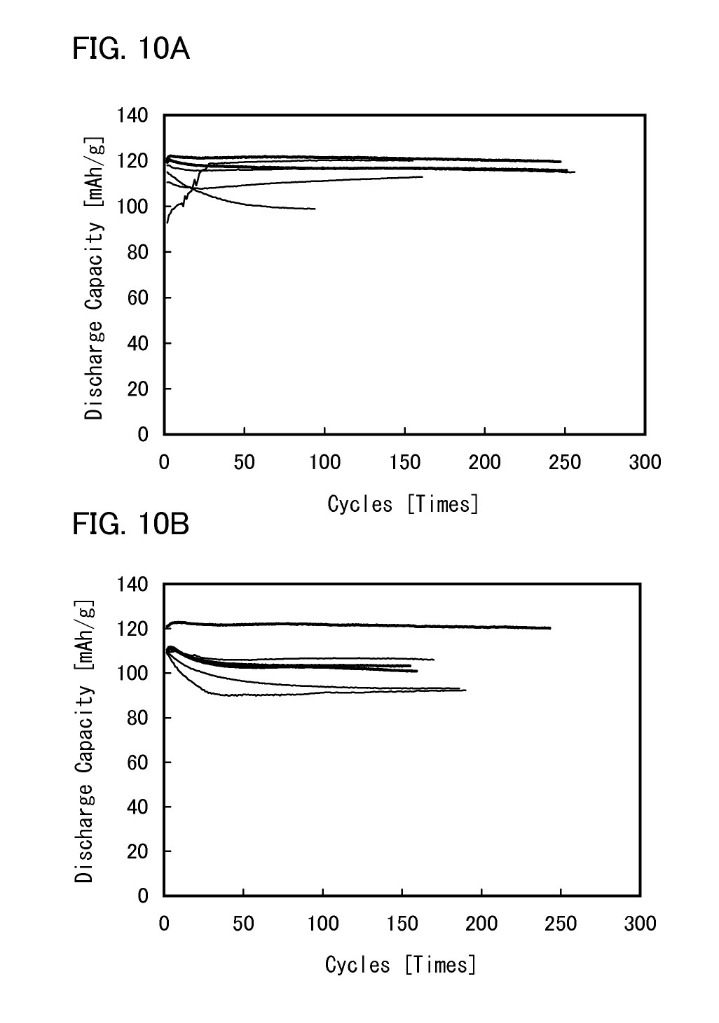

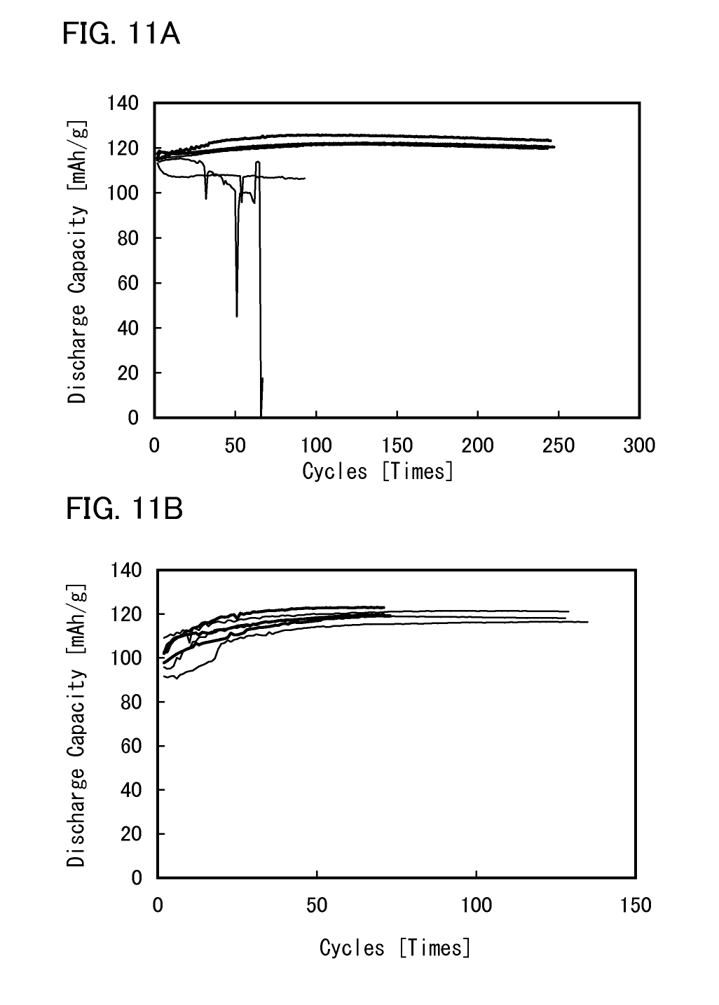

FIGS. 10A and 10B show results of cycle characteristics of the battery cells A and B, respectively, and FIGS. 11A and 11B show results of cycle characteristics of the battery cells C and D, respectively. In each of FIGS. 10A and 10B and FIGS. 11A and 11B, the horizontal axis represents the number of cycles [times] and the vertical axis represents discharge capacity [mAh/g]. Moreover, in FIGS. 10A and 10B and FIGS. 11A and 11B, bold lines represent results in the case of inputting a reverse pulse to the battery cells during charging and thin lines represent results in the case of not inputting a reverse pulse to the battery cells during charging.

As shown in FIGS. 10A and 10B and FIGS. 11A and 11B, in the case of not inputting a reverse pulse to the battery cells during the charging, the battery cell A with a capacity ratio of 85% and the battery cell C with a capacity ratio of 60% show abnormal behavior. In contrast, in the case of inputting a reverse pulse to the battery cells during the charging, stable cycle characteristics are shown in all the conditions.

This application is based on Japanese Patent Application serial no. 2013-004161 filed with Japan Patent Office on Jan. 14, 2013, the entire contents of which are hereby incorporated by reference.

What is claimed is:

1. An electronic device comprising a plurality of battery cells,
the plurality of battery cells each comprising:
a first electrode;
a second electrode; and
an electrolytic solution between the first electrode and the second electrode,
wherein a reaction product that grows from a surface of the first electrode due to a first current between the first electrode and the second electrode is dissolved from a tip or a surface of the reaction product by applying a signal to supply a second current reverse to the first current,
wherein the plurality of battery cells are connected in series, and
wherein the electronic device is stored in an underfloor space surrounded by a base and a floor of a building.

2. The electronic device according to claim 1,
wherein the first electrode is a negative electrode, and
wherein the second electrode is a positive electrode.

3. The electronic device according to claim 1,
wherein the first electrode is a positive electrode, and
wherein the second electrode is a negative electrode.

4. The electronic device according to claim 1,
wherein the electronic device is a rechargeable battery.

5. An electronic device comprising a plurality of battery cells,
the plurality of battery cells each comprising:
a first electrode;
a second electrode; and
an electrolytic solution between the first electrode and the second electrode,
wherein a reaction product growing from a surface of the first electrode due to a first current between the first electrode and the second electrode in a certain period is dissolved from a tip or a surface of the reaction product by applying a signal to supply a second current reverse to the first current in a period shorter than the certain period,
wherein the plurality of battery cells are connected in series, and
wherein the electronic device is stored in an underfloor space surrounded by a base and a floor of a building.

6. The electronic device according to claim 5,
wherein the first electrode is a negative electrode, and
wherein the second electrode is a positive electrode.

7. The electronic device according to claim 5,
wherein the first electrode is a positive electrode, and
wherein the second electrode is a negative electrode.

8. The electronic device according to claim 5,
wherein the electronic device is a rechargeable battery.

9. An electronic device comprising a plurality of battery cells,
the plurality of battery cells each comprising:
a first electrode;
a second electrode; and
an electrolytic solution between the first electrode and the second electrode,
wherein a reaction product growing from a surface of the first electrode due to a first current between the first electrode and the second electrode is dissolved from a tip or a surface of the reaction product by applying a signal to supply a second current reverse to the first current,
wherein after the reaction product is dissolved, the first current between the first electrode and the second electrode is applied
wherein the first current and the second current between the first electrode and the second electrode are alternately and repeatedly applied,
wherein the plurality of battery cells are connected in series, and
wherein the electronic device is stored in an underfloor space surrounded by a base and a floor of a building.

10. The electronic device according to claim 9,
wherein the first electrode is a negative electrode, and
wherein the second electrode is a positive electrode.

11. The electronic device according to claim 9,
wherein the first electrode is a positive electrode, and
wherein the second electrode is a negative electrode.

12. The electronic device according to claim 9,
wherein the electronic device is a rechargeable battery.

13. An electronic device comprising a plurality of battery cells,
the plurality of battery cells each comprising:
a first electrode;
a protective film partly covering the first electrode;
a second electrode; and
an electrolytic solution between the first electrode and the second electrode,
wherein a reaction product growing from a region of a surface of the first electrode due to a first current between the first electrode and the second electrode is dissolved by applying a signal to supply a second current reverse to the first current,
wherein the region is not covered by the protective film,
wherein the plurality of battery cells are connected in series, and
wherein the electronic device is stored in an underfloor space surrounded by a base and a floor of a building.

14. The electronic device according to claim 13,
wherein the first electrode is a negative electrode, and
wherein the second electrode is a positive electrode.

15. The electronic device according to claim 13,
wherein the first electrode is a positive electrode, and
wherein the second electrode is a negative electrode.

16. The electronic device according to claim 13,
wherein the electronic device is a rechargeable battery.
